(19) United States
(12) Patent Application Publication
(10) Pub. No.: US 2007/0070446 A1
(43) Pub. Date: Mar. 29, 2007

(54) Image scanner with heating radiating device

(75) Inventor: Hsi-Yu Chen, Taipei (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Primax Electronics Ltd.

(21) Appl. No.: 11/280,479

(22) Filed: Nov. 16, 2005

(30) Foreign Application Priority Data
Sep. 27, 2005 (TW) 094133458

(51) Int. Cl. H04N 1/04

(52) U.S. Cl. 358/474

(57) ABSTRACT

An image scanner with a heat radiating device is disclosed. The image scanner comprises a housing and a scanning module installed therein. The scanning module has a light source for generating light for scan. A first heat radiating plate is installed at a scanning module home position in the housing and a second heat radiating plate is fixed at the bottom of the housing. The first and second heat radiating plates are connected together to disperse heat out of the scanner housing.

### FIELD OF THE INVENTION

The present invention relates to an image scanner, and more particularly to an image scanner with a heat radiating device.

### BACKGROUND OF THE INVENTION

Heat radiating issue is important for electronic devices including image scanners.

The heat inside image scanners is generally generated by light source, such as light tubes and tube inverters. The heat will impact the operation of elements of scanners, such as image sensors. If the heat generated by the light source were not properly dealt with, it will reduce image quality.

Today, the heat radiating issue is more important than before. Because high resolution image scanners usually use two light tubes to provide higher luminance for scanning and the heat generated by two tubes is much more than that by one tube.

The Taiwan Utility Model Publication No. 461657 titled “Heat radiating mechanism for optical scanner light source” disclosed a device for solving the problem. The 461657 publication attached a heat radiating plate on the scanner's light stand to radiate heat from light tube and disperse the heat out of the scanner by a fan.

However, dust is drawn into the scanner when the fan is running. The dust will pollute the elements and circuits inside the scanner.

It is therefore necessary to provide an image scanner which provides improved solution for heat problem.

### SUMMARY OF THE INVENTION

It is an object of the present invention to provide an image scanner with a heat radiating device which can disperse heat out of scanner.

In accordance with an aspect of the present invention, there is provided an image scanner with heat radiating device, comprising:
a housing;
a scanning module installed in the housing and staying at a home position when not performing scans, comprising:

a light tube, for generating light for scan;

a tube inverter, for providing a starting voltage to the light tube;
a first heat radiating plate set in the housing; and
a second heat radiating plate set at the home position in the bottom of the housing and connected to the first heat radiating plate by heat conduction connection.

In a first preferred embodiment, the housing comprises an upper cover and a bottom cover, and the first heat radiating plate is attached on an internal surface of the upper cover.

In a second embodiment, the first heat radiating plate is a cover of the scanner module, and the scanning module further comprises a heat conduction rubber attached on the inverter, and the image scanner further comprises a metal elastic slice which contact both the first and second heat radiating plates.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is an exploded view of an image scanner according to a preferred embodiment of the present invention.

### DETAILED DESCRIPTION OF THE PREFERRED EMBODIMENT

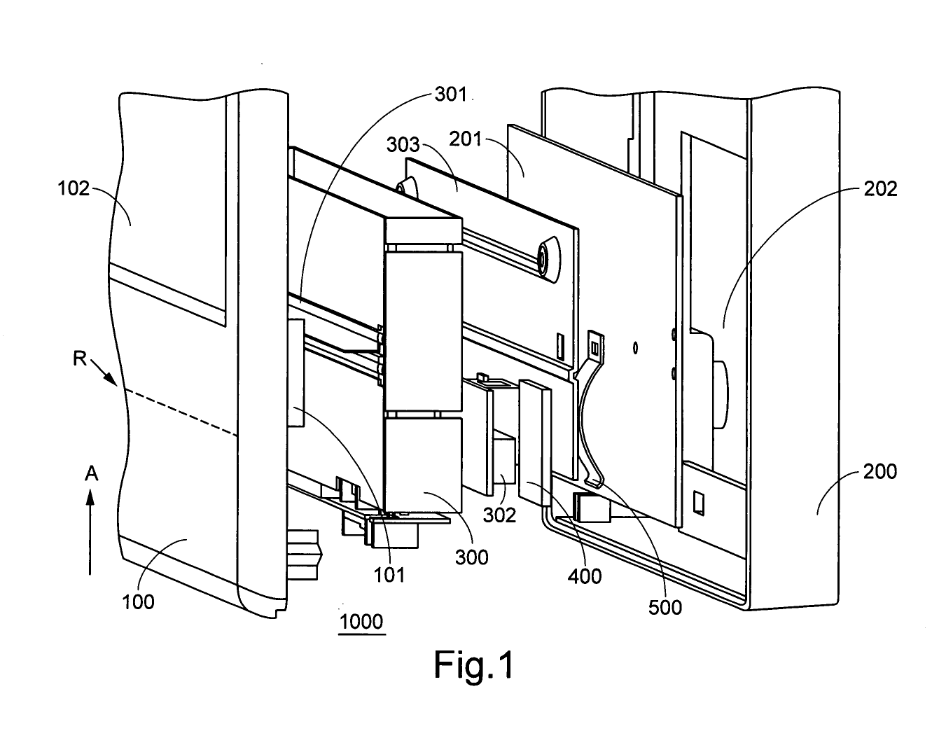

Please refer to FIGS. 1, which is an exploded view of an image scanner according to a preferred embodiment of the present invention. The heat radiating device of the present invention is used for dispersing the heat from light tube and tube inverter.

The image scanner 1000 of the invention comprises a housing and a scanning module 300 therein. The scanner housing comprises an upper cover 100 and a bottom cover 200. The scanning module 300 comprises a light tube 301, a tube inverter 302 and a cover plate 303 of the scanning module 300. A tube heat radiating plate 101 is set at the inner surface of the upper cover 100, and a bottom heat radiating plate 201 is set at an internal surface of the bottom cover 200. A heat transmitting element 500 is set between the cover plate 303 and the tube heat radiating plate 101. In a preferred embodiment, the heat transmitting element 500 is a metal elastic slice.

The upper cover 100 has a glass plate 102 for placing a document thereon and the scanning module 300 is moved in the direction A to scan the document. When a scan is completed, the scanning module 300 is moved back to one side of the housing, that is, position R. The position R is called “Home position”.

The tube heat radiating plate 101 is of elongate shape and made of the material which can absorb heat, such as metal slices. The tube heat radiating plate 101 is set at the home position R with a longer side perpendicular to the scan direction A.

The bottom cover 200 has a rectangular through hole 202 formed at the home position R, and the bottom heat radiation plate 201 is fixed on the through hole 202 with conventional means. Heat inside the scanner can be dispersed out of the scanner housing via the through hole 202.

Whenever the scanning module 300 is in a warm-up state or completed a scan, the scanning module 300 moves back to the home position R. At this moment, heat from tube 301 will be absorbed by tube heat radiating plate 101. Since the tube heat radiating plate 101 is connected with the bottom heat radiating plate 201 by way of heat conduction connection, the heat absorbed by the tube heat radiating plate 101 can be transmitted to the bottom heat radiating plate 201 and dispersed out of the scanner via the through hole 202. The heat conduction connection can be achieved by elongating two end of the tube heat radiating plate 101 to contact the bottom heat radiating plate 201 directly , or connecting them with a heat conduction material.

Besides, the present invention also provides a heat radiation device for tube inverter 302.

Please refer to FIG. 1 again. A heat conduction rubber 400 is attached on the inverter 302 and contact with the cover plate 300 of scanner module.

The cover plate 300 of scanner module 300 is made of metal and is heat conductive. Heat from inverter 302 is transmitted by heat conduction rubber 400 to cover plate 303, then to the heat transmitting element 500 and dispersed out of scanner by the bottom heat radiating plate 201.

The present invention provides heat radiating devices for scanner light source including light tube and tube inverter which are the main heat generator of scanner and provides bottom heat radiating plate to disperse heat out of scanner. Comparing with the mentioned prior art, the present invention can avoid the problem of dust pollution.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An image scanner with heat radiating device, comprising:
a housing;
a scanning module installed in the housing and staying at a home position when not performing scans, comprising:
a light tube, for generating light for scan;
a tube inverter, for providing a starting voltage to the light tube;
a first heat radiating plate set in the housing; and
a second heat radiating plate set at the home position in the bottom of the housing and connected to the first heat radiating plate by heat conduction connection.

2. The image scanner with heat radiating device according to claim 1, wherein the housing comprises an upper cover and a bottom cover, and the first heat radiating plate is attached on an internal surface of the upper cover.

3. The image scanner with heat radiating device according to claim 1, wherein the first heat radiating plate is the scanner module's cover, and the scanning module further comprises a heat conduction rubber attached on the inverter, and the image scanner further comprises a metal elastic slice which contact both the first and second heat radiating plates.

4. An image scanner with heat radiating device, comprising:
an upper cover;
a bottom cover;
a scanning module installed between the upper cover and the bottom cover and staying at a home position when not performing any scans, comprising a light tube;
a tube heat radiating plate attached at the home position on a internal surface of the upper cover; and
a bottom heat radiating plate installed at the home position on the bottom cover and connected with the first heat radiating plate by heat conduction connection.

5. An image scanner with heat radiating device, comprising:
an upper cover;
a bottom cover;
a scanning module installed between the upper cover and the bottom cover and staying at a home position when not performing scans, comprising:
a light tube; and
a tube inverter, for providing a starting voltage to the light tube;
a cover of the scanning module, which is made of heat conduction material; and
a heat conduction rubber attached on the inverter;
a bottom heat radiating plate set at the home position on the bottom cover; and
a heat conducting element, which contact both the cover of the scanning module and the bottom heat radiating plate.

6. The image scanner with heat radiating device according to claim 5, wherein the heat conducting element is a metal elastic slice.
